(19) United States
(12) Patent Application Publication
(10) Pub. No.: US 2019/0116184 A1
(43) Pub. Date: Apr. 18, 2019

(54) ASSEMBLY AND METHOD FOR ACCESSING SECURE NETWORKS USING OPTICALLY-SENSED INFORMATION

(71) Applicant: General Electric Company, Schenectady, NY (US)

(72) Inventor: Morne NESER, Lachine (CA)

(21) Appl. No.: 15/881,377

(22) Filed: Jan. 26, 2018

Related U.S. Application Data
(60) Provisional application No. 62/573,469, filed on Oct. 17, 2017.

(51) Int. Cl. H04L 29/06; H04N 7/18; G06K 7/14

(52) U.S. Cl. CPC H04L 63/10; H04L 63/083; G06K 7/1417; G06K 7/1413; H04N 7/185

(57) ABSTRACT

An assembly includes an optical sensor configured to optically detect information printed or displayed on an object. The information includes one or more of an operational parameter of a device or an access credential required for communication via one or more secure networks. The assembly also includes control circuitry configured to one or more of direct a communication unit to access the one or more secure networks using the access credential that is detected using the optical sensor or change an operational setting of the device using the operational parameter that is detected using the optical sensor.

### CROSS-REFERENCE TO RELATED APPLICATIONS

This application claims priority to U.S. Provisional Application No. 62/573,469, which was filed on 17 Oct. 2017, and the entire disclosure of which is incorporated herein by reference.

### BACKGROUND

A wide variety of electronic devices communicate via computer communication networks. The devices can include computers, mobile phones, cameras, other types of sensors, etc. The networks can be publicly accessible or secured. Publicly accessible networks may be accessed by these devices without providing access credentials, such as a username, network address, password, or other non-public and/or uniquely identifying information. Secure networks, however, may require that a device provide an access credential before the device is allowed to communicate via the network. For example, a password-protected network may include routers and other devices that do not allow the sending or receiving of data packets through or using the network without first providing valid access credentials.

Providing access credentials for many devices may be a relatively simple and straight-forward task. A user an input the access credentials via an input of the device, such as by typing in a password into a keyboard. But, not all devices have an easily accessible way to provide the access credential. For example, some security systems, cameras mounted on light fixtures, and the like, may be enclosed in a secure or locked housing and/or may be in locations that are not easily accessed. These types of devices may need to be taken apart using specialized tools and/or may need to be accessed in ways that are difficult and time-consuming to input the access credentials needed for these devices to access and communicate via secure networks.

### BRIEF DESCRIPTION

In one embodiment, an assembly includes an optical sensor configured to optically detect information printed or displayed on an object. The information includes one or more of an operational parameter of a device or an access credential required for communication via one or more secure networks. The assembly also includes control circuitry configured to one or more of direct a communication unit to access the one or more secure networks using the access credential that is detected using the optical sensor or change an operational setting of the device using the operational parameter that is detected using the optical sensor.

In one embodiment, a method includes optically detecting information printed or displayed on an object. The information includes one or more of an operational parameter of a device or an access credential required for communication via one or more secure networks. The method also includes one or more of changing an operational setting of the device using the operational parameter that is optically detected by the optical sensor, or accessing the one or more secure networks and communicating a signal via the one or more secure networks.

In one embodiment, an assembly includes a camera configured to generate image data representative of a field of view of the camera, a controller configured to monitor activity within the field of view of the camera based on the image data, and a communication unit configured to communicate a signal representative of the activity that is monitored by the controller via one or more restricted communication paths that require an access credential to communicate via the one or more restricted communication paths. The controller is configured to obtain the access credential needed for communication via the one or more restricted communication paths by optically detecting one or more symbols representative of the access credential using the camera.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of an optical assembly;

FIG. 2 illustrates one embodiment of operation of the optical assembly shown in FIG. 1 to optically determine the access credential for the restricted network;

FIG. 3 illustrates examples of symbols that can be presented on a tangible object for providing the access credential to the restricted network to the optical assembly shown in FIGS. 1 and 2; and

FIG. 4 illustrates one embodiment of a method for optically determining access credentials to secured or restricted communication networks.

### DETAILED DESCRIPTION

The inventive subject matter described herein provides assemblies and methods that optically determine access credentials for the assemblies to access and communicate via secure computer communication networks. The assemblies can include optical sensors (such as cameras) that monitor activities within fields of view of the optical sensors. These assemblies can include security cameras, cameras coupled with light fixtures, and the like, for optically monitoring activity such as pedestrian activity, automobile activity, etc. The assemblies can communicate information about the monitored activity (e.g., images and/or video) to a remote location via one or more secured networks, such as wireless and/or wired networks. These networks can require the assemblies to provide an access credential, such as a user login, password, network address, or the like, before the assemblies can communicate data via the networks.

The assemblies can optically determine the access credential without requiring a user manually inputting the access credentials into the assemblies. For example, the same or an additional optical sensor can view one or more symbols, indicia or indicium, text, numbers, or the like, that represent the access credential. This viewed information can be a bar code, a quick response code, or other symbol representative of the access credential. Optionally, the viewed information can be the alphanumeric text that is the access credential (e.g., the password). The assembly determines the access credential from the access credential being printed onto a substrate (e.g., a piece of paper, card, etc.) or electronically displayed (e.g., on the display of a mobile phone). The assembly then provides the access credential to the secure network so that the assembly is able to access and communicate signals indicative of activity monitored by the optical sensor to one or more other locations via restricted communication paths of the secure network.

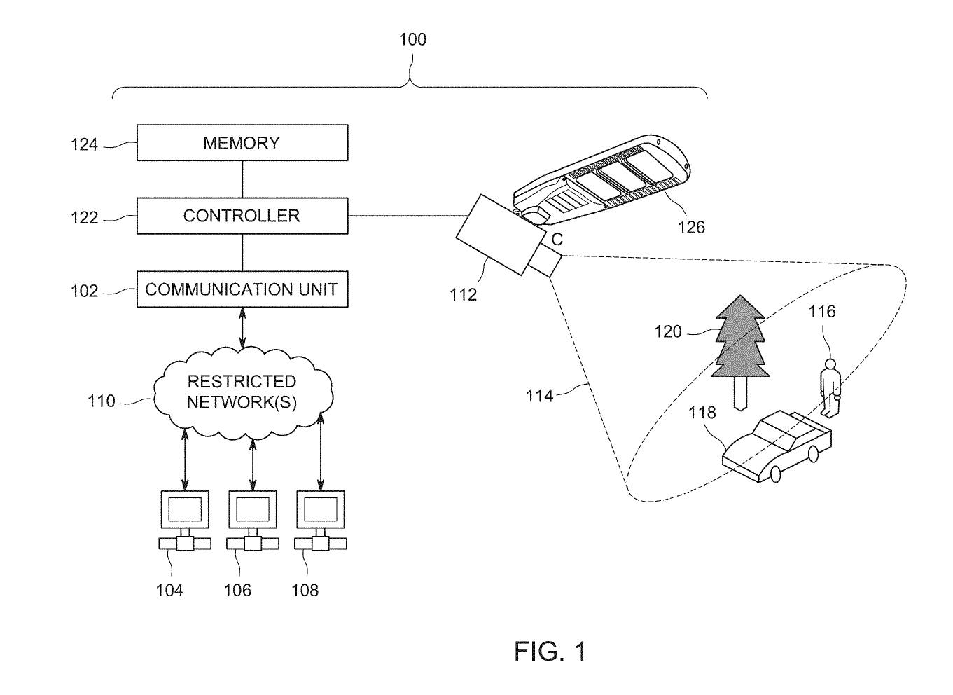

FIG. 1 illustrates one embodiment of an optical assembly 100. The optical assembly 100 includes a communication unit 102 that communicates one or more signals with one or more devices 104, 106, 108 via one or more restricted communication paths of a secured computer communication network 110 (“Restricted Network(s)” in FIG. 1). The communication unit 102 can include hardware circuitry that includes and/or is connected with one or more modems, routers, transceivers, or the like. The secured network 110 can represent one or more wired and/or wireless networks of restricted communication paths that include routers, modems, and the like, and that require devices and assemblies to provide access credentials to communicate electronic signals within, through, and/or via the network 110. For example, the secured network 110 may require devices to provide a password, network address, login, or the like, before the devices can send or receive signals via the network 110. The devices 104, 106, 108 can represent one or more computers or computer processors, such as remotely located computers that remotely monitor a location via the assembly 100.

The assembly 100 includes an optical sensor 112 that generates optical data representative of activity or objects within a field of view 114 of the optical sensor 112. The optical sensor 112 can include or represent one or more cameras that generate images and/or videos indicative of pedestrians (or other persons) 116, vehicles 118, or other objects 120 within the field of view 114 of the camera(s). In one embodiment, the optical sensor 112 can operate as a security camera to send images and/or videos to the devices 104, 106, 108 via the network 110 to allow the devices 104, 106, 108 to be used for manual and/or automated monitoring of the area that includes the field of view 114. As another example, the optical sensor 112 can operate as an activity camera to send images and/or videos to the devices 104, 106, 108 via the network 110 to allow the devices 104, 106, 108 to be used for recording accidents or other activity within the field of view 114. As another example, the optical sensor 112 can operate as an activity camera to send images and/or videos to the devices 104, 106, 108 via the network 110 to allow the devices 104, 106, 108 to be used for tracking available parking spaces, or the like.

The assembly 100 also includes control circuitry 122 (“Controller” in FIG. 1) that represents hardware circuitry that includes and/or is connected with one or more computer processors (e.g., microprocessors, field programmable gate arrays, integrated circuits, etc.) that control operation of the assembly 100. The control circuitry 122 can obtain the optical data from the optical sensor 112 and direct the communication unit 102 to communicate the optical data to the device 104, 106, and/or 108 in one or more signals send via the restricted network(s) 110. The control circuitry 122 can determine and provide the access credential(s) required for communication via the network(s) 110 to the communication unit 102 to allow the communication unit 102 to communicate using the network(s) 110.

In one embodiment, the control circuitry 122 determines the access credential using only the optical sensor 112, and does not receive or determine the access credential from any other source, such as via communication from a device other than the optical sensor 112 (e.g., a keyboard, microphone, touchscreen, BLUETOOTH device, wireless device, infrared device, radio frequency identification device, etc.). The control circuitry 122 then provides the access credential to the communication unit 102, which uses the access credential to communicate using the restricted network(s) 110.

In the illustrated embodiment, the assembly 100 also includes a memory 124. The memory 124 can represent one or more tangible and non-transitory computer-readable storage media, such as one or more hard drives, flash drives, optical drives, solid state drives, or the like. The memory 124 can be used by the control circuitry 122 to store access credentials, image data, and/or other information.

The assembly 100 optionally includes a lighting fixture 126. The lighting fixture 126 can represent a street light or other device that generates light. In one embodiment, the assembly 100 is a lighting fixture that both generates light for illuminating at least part of the field of view 114 and that includes the optical sensor 112 for monitoring activity (or lack thereof) within the field of view 114. For example, the assembly 100 may be used as a street light that is elevated above part of a sidewalk or a street. The components of the assembly 100 can be located within the lighting fixture 126.

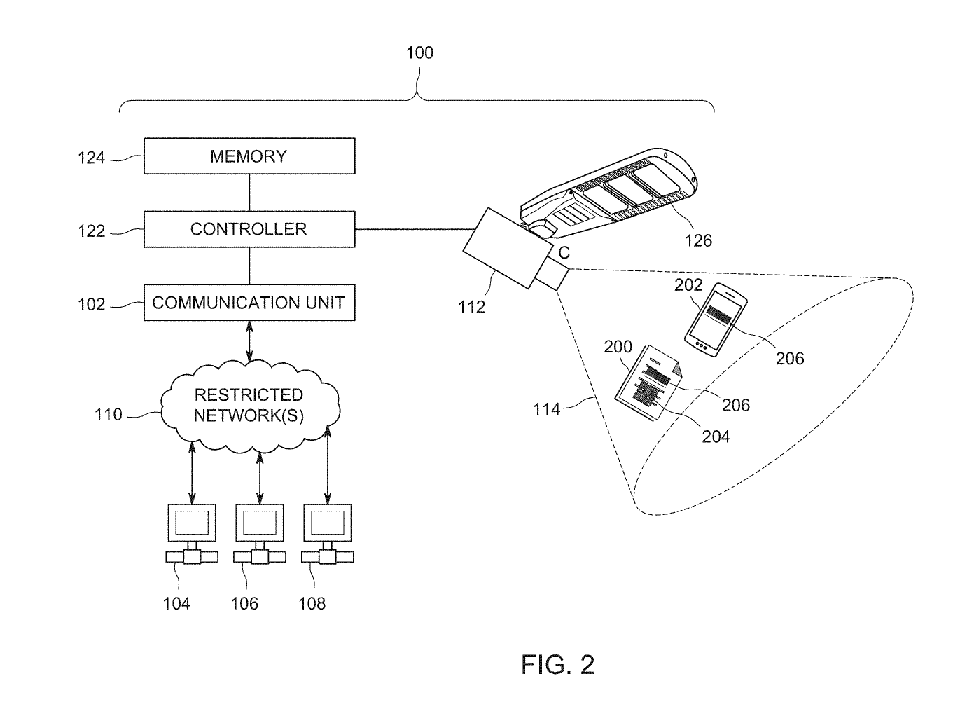

FIG. 2 illustrates one embodiment of operation of the assembly 100 to optically determine the access credential for the restricted network(s) 110. The assembly 100 may not have the access credential needed to communicate via the restricted network(s) 110. This may be due to the access credential being changed, the assembly 100 being a new installation that does not have the access credential, the network 110 being a new or modified network, or the like. The access credential can be provided to the assembly 100 by positioning a tangible object 200, 202 having one or more symbols 204, 206 printed or displayed thereon. For example, a document 200 having a bar code, quick response code, alphanumeric text, or other indicia tangibly printed on the document 200 using ink can be placed within the field of view 114 of the optical sensor 112. The bar code, quick response code, alphanumeric text, or other indicia printed on the document 200 can be the symbols 204, 206 that represent the access credential required for the network 110. Optionally, a tablet computer, mobile phone, or other electronic device 202 can be placed in the field of view 114 of the optical sensor 112, with the symbols 206 electronically displayed on a screen of the device 202.

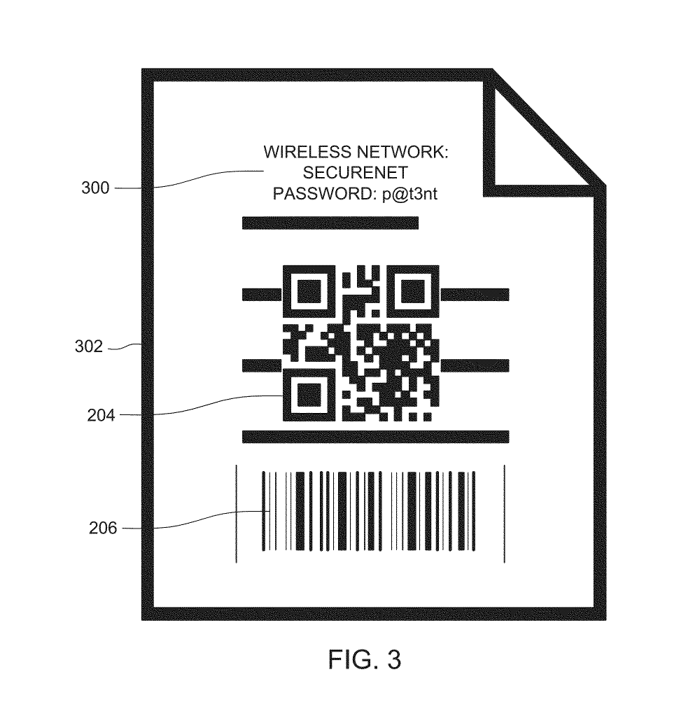

With continued reference to the assembly 100 shown in FIG. 2, FIG. 3 illustrates examples of symbols 204, 206, 300 that can be presented on a tangible object 302 for providing the access credential to the network(s) 110 to the assembly 100 shown in FIGS. 1 and 2. The object 302 is shown as a document, but optionally can be a mobile phone, tablet computer, or other electronic device. The object 302 can represent one or more of the objects 200, 202 shown in FIG. 2. The symbol 204 is a quick response code, the symbol 206 is a bar code, and the symbol 300 is a collection of alphanumeric text. The bar code and quick response code can represent the access credential. The alphanumeric text can be the access credential written out. The symbol 300 may be used in place of one or more of the symbols 204, 206 shown in FIG. 2.

The control circuitry 122 can examine image data generated by the optical sensor 112 that includes one or more of the symbols 204, 206, 300 and determine the access credential from the symbols 204, 206, 300. With respect to the bar and quick response codes, the control circuitry 122 can include software that deciphers the access credentials from the codes. With respect to the symbols 300, the control circuitry 122 can use optical character recognition that deciphers the access credentials.

The control circuitry 122 then provides the access credential determined from the object(s) 200, 202, 302 to the communication unit 102. The communication unit 102 supplies the access credential to the network 110 so that the network 110 recognizes the communication unit 102 as an approved communication device for communicating using the network 110. The communication unit 102 can then send and/or receive signals using the network 110. In one embodiment, the communication unit 102 sends signals indicative of the images and/or video of the field of view 114 to the devices 104, 106, 108 via the network 110, receives control signals from the devices 104, 106, 108 via the network 110 that control activation, deactivation, focus, aperture size, or the like, of the optical sensor 112, and/or sends and receives the images, videos, and control signals using the network 110. If the communication unit 110 previously communicated using an outdated or replaced access credential stored in the memory 124, then the control circuitry 122 can update the memory 124 with the new or updated access credential that is optically determined.

Optionally, information in addition to or in place of the access credential can be detected and determined by the combination of the optical sensor 112 and the control circuitry 122. For example, operational parameters such as operational settings, calibration values, or the like, can be detected. The operational settings can be settings of the optical sensor 112, the communication unit 102, the lighting fixture 126, and/or another device 128 (such as a computer, a sensor, a clock, or the like). These settings can include an instruction to turn on or off, an aperture and/or f-stop value, a brightness of light to be generated, a communication channel, etc. This can be useful when other techniques of communicating (e.g., wireless or otherwise) are not available or feasible. For example, a sealed device 128 may require calibration before operation in the field. Identification and interference among multiple wireless units in close proximity to the sealed device 128 could pose a problem for wirelessly sending the calibration values. Optical communication or detection of the values can be more reliable. As another example, a device 128 may not have an input to receive such settings or values, and optical detection of the settings or values may be the only way to get the information to the device 128. While the description herein focuses on access credentials, not all embodiments of the inventive subject matter are so limited. One or more embodiments may obtain operational parameters instead of or in addition to the access credentials using the optical sensor 112.

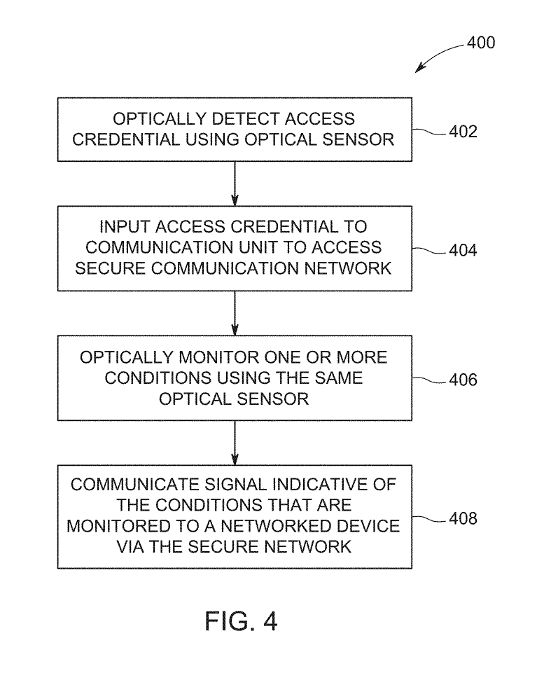

FIG. 4 illustrates one embodiment of a method 400 for optically determining access credentials to secured or restricted communication networks. The method 400 can be performed by the assembly 100 in order to determine the access credential needed for the assembly 100 to communicate using the restricted network 110. At 402, the access credential is optically determined using the optical sensor 112. The access credential can be determined by the optical sensor 112 generating image data and/or video data that depicts the access credential. This data can be communicated to the control circuitry 122, which scans the symbols in the data that are representative of the access credential to determine the access credential.

At 404, the access credential that is determined is provided to the communication unit 102. The control circuitry 122 can communicate the access credential to the communication unit 102 via one or more wired and/or wireless connections. At 406, one or more conditions are optically monitored using the same optical sensor 112. For example, the same camera that generated the image of the symbols representative of the access credential also can generate images and/or video representative of activities, movements, or the like, within the same field of view 114 of the camera.

At 408, a signal indicative or representative of the conditions that are monitored by the optical sensor 112 are communicated via the network 110 to one or more networked devices 104, 106, and/or 108. For example, the communication unit 102 can send images and/or videos to a remote monitoring station computer that remotely monitors activities within the field of view of the optical sensor 112. As another example, the control circuitry 122 can monitor activity within the field of view 114 and, responsive to detecting activity (e.g., movement), identifying one or more objects in the field of view 114, or the like, the control circuitry 122 can communicate the signal to the devices 104, 106, and/or 108 to inform the devices 104, 106, and/or 108 of the activity. The monitoring of conditions that is performed at 406 can occur prior to, concurrent with, or subsequent to the operations performed at 402 and/or 404 in different embodiments.

In one embodiment, an assembly includes an optical sensor configured to optically detect information printed or displayed on an object. The information includes one or more of an operational parameter of a device or an access credential required for communication via one or more secure networks. The assembly also includes control circuitry configured to one or more of direct a communication unit to access the one or more secure networks using the access credential that is detected using the optical sensor or change an operational setting of the device using the operational parameter that is detected using the optical sensor.

Optionally, the optical sensor also is configured to generate image data representative of a field of view of the optical sensor, and the control circuitry is configured to monitor one or more conditions based on the image data that is generated by the optical sensor and communicate information about the one or more conditions as the signal that is communicated via the one or more restricted communication paths.

Optionally, the communication unit is configured to wirelessly communicate a signal via one or more restricted communication paths of the one or more secure networks only after the access credential is detected by the optical sensor.

Optionally, the optical sensor is configured to optically detect the access credential, and the access credential is one or more of a login name, a password, a combination of the login name and the password, or a network address in the one or more secure networks.

Optionally, the assembly also includes the communication unit, and the communication unit, the optical sensor, and the control circuitry are disposed within or coupled with a lighting fixture.

Optionally, the optical sensor is configured to optically detect a bar code or a quick response code representative of the information that is printed or displayed on the object.

Optionally, the optical sensor is configured to optically detect one or more alphabet letters, one or more numbers, one or more symbols, or a combination thereof that represent the information that is printed or displayed on the object.

Optionally, the control circuitry is configured to determine the information that is printed or displayed on the object using optical character recognition and image data generated by the optical sensor that represents the information that is printed or displayed on the object.

Optionally, the optical sensor is configured to optically detect the information as information that is tangibly printed on a surface of the object.

Optionally, the optical sensor is configured to optically detect the information as information that is electronically presented on a display of the object.

Optionally, the information that is printed or displayed on the object is the access credential, and the optical sensor is configured to optically detect a new or updated access credential of the one or more secure networks and the control circuitry is configured to direct the communication unit to access the one or more secure networks using the updated access credential that is detected.

In one embodiment, a method includes optically detecting information printed or displayed on an object. The information includes one or more of an operational parameter of a device or an access credential required for communication via one or more secure networks. The method also includes one or more of changing an operational setting of the device using the operational parameter that is optically detected by the optical sensor, or accessing the one or more secure networks and communicating a signal via the one or more secure networks.

Optionally, the method also includes communicating additional information representative of a field of view of the optical sensor as the signal that is communicated via the one or more secure networks.

Optionally, the method includes optically detecting the information that includes the access credential, and the access credential is one or more of a login name, a password, a combination of the login name and the password, or a network address of the one or more secure networks.

Optionally, optically detecting the information includes optically detecting a bar code or a quick response code representative of the information.

Optionally, optically detecting the information includes optically detecting one or more alphabet letters, one or more numbers, one or more symbols, or a combination thereof that represent the information.

In one embodiment, an assembly includes a camera configured to generate image data representative of a field of view of the camera, a controller configured to monitor activity within the field of view of the camera based on the image data, and a communication unit configured to communicate a signal representative of the activity that is monitored by the controller via one or more restricted communication paths that require an access credential to communicate via the one or more restricted communication paths. The controller is configured to obtain the access credential needed for communication via the one or more restricted communication paths by optically detecting one or more symbols representative of the access credential using the camera.

Optionally, the access credential is one or more of a login name, a password, a combination of the login name and the password, or a network address of a secure network that includes the one or more restricted communication paths.

Optionally, the camera is configured to optically detect a bar code or a quick response code as the one or more symbols that are representative of the access credential.

Optionally, the control circuitry is configured to determine the access credential using optical character recognition and image data generated by the camera that represents the access credential.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. An assembly comprising:
an optical sensor configured to optically detect information printed or displayed on an object, the information including one or more of an operational parameter of a device or an access credential required for communication via one or more secure networks; and
control circuitry configured to one or more of direct a communication unit to access the one or more secure networks using the access credential that is detected using the optical sensor or change an operational setting of the device using the operational parameter that is detected using the optical sensor.

2. The assembly of claim 1, wherein the optical sensor also is configured to generate image data representative of a field of view of the optical sensor, and wherein the control circuitry is configured to monitor one or more conditions based on the image data that is generated by the optical sensor and communicate information about the one or more conditions as the signal that is communicated via the one or more restricted communication paths.

3. The assembly of claim 1, wherein the communication unit is configured to wirelessly communicate a signal via one or more restricted communication paths of the one or more secure networks only after the access credential is detected by the optical sensor.

4. The assembly of claim 1, wherein the optical sensor is configured to optically detect the access credential, and wherein the access credential is one or more of a login name, a password, a combination of the login name and the password, or a network address in the one or more secure networks.

5. The assembly of claim 1, further comprising the communication unit, wherein the communication unit, the optical sensor, and the control circuitry are disposed within or coupled with a lighting fixture.

6. The assembly of claim 1, wherein the optical sensor is configured to optically detect a bar code or a quick response code representative of the information that is printed or displayed on the object.

7. The assembly of claim 1, wherein the optical sensor is configured to optically detect one or more alphabet letters, one or more numbers, one or more symbols, or a combination thereof that represent the information that is printed or displayed on the object.

8. The assembly of claim 1, wherein the control circuitry is configured to determine the information that is printed or displayed on the object using optical character recognition and image data generated by the optical sensor that represents the information that is printed or displayed on the object.

9. The assembly of claim 1, wherein the optical sensor is configured to optically detect the information as information that is tangibly printed on a surface of the object.

10. The assembly of claim 1, wherein the optical sensor is configured to optically detect the information as information that is electronically presented on a display of the object.

11. The assembly of claim 1, wherein the information that is printed or displayed on the object is the access credential, and the optical sensor is configured to optically detect a new or updated access credential of the one or more secure networks and the control circuitry is configured to direct the communication unit to access the one or more secure networks using the updated access credential that is detected.

12. A method comprising:
optically detecting information printed or displayed on an object using an optical sensor, the information including one or more of an operational parameter of a device or an access credential required for communication via one or more secure networks; and
one or more of:
changing an operational setting of the device using the operational parameter that is optically detected by the optical sensor, or
accessing the one or more secure networks and communicating a signal via the one or more secure networks.

13. The method of claim 12, further comprising communicating additional information representative of a field of view of the optical sensor as the signal that is communicated via the one or more secure networks.

14. The method of claim 12, wherein the method includes optically detecting the information that includes the access credential, wherein the access credential is one or more of a login name, a password, a combination of the login name and the password, or a network address of the one or more secure networks.

15. The method of claim 12, wherein optically detecting the information includes optically detecting a bar code or a quick response code representative of the information.

16. The method of claim 12, wherein optically detecting the information includes optically detecting one or more alphabet letters, one or more numbers, one or more symbols, or a combination thereof that represent the information.

17. An assembly comprising:
a camera configured to generate image data representative of a field of view of the camera;
a controller configured to monitor activity within the field of view of the camera based on the image data; and
a communication unit configured to communicate a signal representative of the activity that is monitored by the controller via one or more restricted communication paths that require an access credential to communicate via the one or more restricted communication paths,
wherein the controller is configured to obtain the access credential needed for communication via the one or more restricted communication paths by optically detecting one or more symbols representative of the access credential using the camera.

18. The assembly of claim 17, wherein the access credential is one or more of a login name, a password, a combination of the login name and the password, or a network address of a secure network that includes the one or more restricted communication paths.

19. The assembly of claim 17, wherein the camera is configured to optically detect a bar code or a quick response code as the one or more symbols that are representative of the access credential.

20. The assembly of claim 17, wherein the controller is configured to determine the access credential using optical character recognition and image data generated by the camera that represents the access credential.
